(19) United States
(12) Patent Application Publication
(10) Pub. No.: US 2010/0257400 A1
(43) Pub. Date: Oct. 7, 2010

(54) NETWORK LOOP HEALING APPARATUS AND METHODS

(76) Inventor: Colin Whitby-Strevens, Ben Lomond, CA (US)

Correspondence Address: GAZDZINSKI & ASSOCIATES, P.C., 16644 WEST BERNARDO DRIVE, SUITE 201, SAN DIEGO, CA, 92127, US

(21) Appl. No.: 12/727,043

(22) Filed: Mar. 18, 2010

Related U.S. Application Data
(60) Provisional application No. 61/161,265, filed on Mar. 18, 2009.

(51) Int. Cl. G06F 11/14; G06F 15/173

(52) U.S. Cl. 714/4; 709/224; 714/E11.113

(57) ABSTRACT

Methods and apparatus for resolving valid networking structures for impromptu or ad hoc networks of audio-visual (A/V) components. In one embodiment, the networks are checked for problematic or “confounding” structures such as loops and non-unique paths between endpoints. Apparatus and methods are also disclosed which provide for network arbitration, and topology resolution. While the network itself is generally unidirectional during functional operation, each component utilizes an auxiliary bi-directional channel to perform the functions of arbitration and topology resolution. Control over network responsibilities may also be transferred from a master node to other nodes in the system for low level topology resolution, and relinquished back to the master node for normal operation.

### PRIORITY

This application claims priority to U.S. Provisional Patent Application Ser. No. 61/161,265 filed Mar. 18, 2009 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The invention relates generally to the field of audio/visual (A/V) consumer electronics devices, and networks thereof. More particularly, in one exemplary aspect, the invention is directed to methods and apparatus adapted to enable detection and quarantine of logical loops created by e.g., accidental/unintentional connection or improper configuration of such devices.

2. Description of Related Technology

DisplayPort (see, inter alia, www.displayport.org) is an exemplary and emerging digital display interface technology specified by the Video Electronics Standards Association (VESA). Current incarnations of the standard specify support for simple networking of digital audio/visual (A/V) interconnects, intended to be used primarily between an arbitrary assembly of multimedia “sources” (e.g., computers or CPUs) and “sinks” (e.g. display monitors, home-theater system, etc.). This interconnection is generally unidirectional in nature; i.e., from source to sink, in current implementations.

Extant DisplayPort technology is an extensible digital interface solution that is designed for a wide variety of performance requirements, and broadly supports PCs, monitors, panels, projectors, and high definition (HD) content applications.

Extant DisplayPort technology is capable of supporting both internal chip-to-chip, and external box-to-box digital display connections. Examples of internal chip-to-chip applications include notebook PCs which drive a display panel from a graphics controller, or display components from display controllers driving the monitor of a TV. Examples of box-to-box applications include display connections between PCs and monitors, and projectors (e.g., not housed within the same physical device). Consolidation of internal and external signaling methods enables the “direct drive” of digital monitors. Direct drive eliminates the need for control circuits, and allows for among other things, cheaper and slimmer displays.

DisplayPort provides inter alia unidirectional transmission of audio and video data from source nodes to sink nodes, and an auxiliary channel (back-channel) for capability and status information to be sent from the sink to the source. The primary and auxiliary channels operate in “master/slave” mode under control of the master node. The master node controls both the low level transmission of data between source and sink, and the higher level management of the display and networking.

The DisplayPort connection includes multiple data lanes (1, 2, or 4 data pairs), and an embedded clock. Unlike other standards (e.g., HDMI, DVI), DisplayPort embeds the clock in the data signal transmission, and requires clock regeneration at the receiver. Audio signals may be optionally included, but are not required. Each data stream has a symbol rate of 1.62 or 2.7 Gbit/s. The bi-directional auxiliary channel (operating at a constant 1 Mbit/s) carries management and device control data. The data transmission protocol in DisplayPort is based on micro-packets which provide extensibility for future feature additions; other transmission protocols (e.g., HDMI, DVI) are based on serial data streams, and are not flexible in this manner.

Unlike typical bus and network structures, unidirectional device topologies (e.g. audio-visual systems such as HDMI, DVI) have resisted bus or network arbitration, as the overhead imposed by such networking layers provides minimal benefit for direct source-to-sink type connections. Typical solutions use a “master-slave” approach, where the master (e.g. source node) controls the bus or network. Some technologies enable a back-channel for sending information from the slave devices to the master. However, such back channels require an existing functional connection (for example, the master must query the slave for the slave's information when a slave asserts an interrupt towards the master).

As technologies for such devices progress toward more complex network structures (e.g., such as those supported by the aforementioned DisplayPort standard having multiple sources, branches and sinks), the previous assumptions suitable for simple buses of unidirectional devices are no longer accurate. Some simple bus topologies are inoperable as network topologies. For example, a network (with no clear master, or multiple potential masters) that contains physical loops can ensnare discovery and addressing mechanisms, and may cause endless logical loops. Accordingly, a mechanism is needed to resolve such potential new structures.

Improved apparatus and methods would ideally enable a network of unidirectional devices by detecting one or more invalid connection conditions (such as a circular or “infinite” loop, and/or duplicate paths). More generally, such apparatus and methods would ensure that the network remains “bounded” regardless of its physical topology (e.g. that logically, each network path has at least two endpoints). Each detected invalid connection would then be selectively chosen for quarantine or other disposition that would remedy the problem.

In addition, improved apparatus and methods would obviate the need for expensive and/or dedicated software or hardware components. Implementations of such schemes could be targeted, for example, for applications having “thin” clients; i.e., clients having little or no innate device driver “intelligence”. Lower-end sources or sinks, or even certain mobile devices (where space, cost, and electrical power consumption are each at a premium) commonly implement such “thin” configurations.

Lastly, exemplary improved apparatus and methods would provide a robust solution, including allowing all reasonable (and even some “unreasonable”) topologies to function where possible.

### SUMMARY OF THE INVENTION

The present invention satisfies the foregoing needs by providing, inter alia, methods and apparatus for enabling detection and quarantine of logical loops created by accidental/unintentional connection or improper configuration of such devices.

In one aspect of the invention, improved methods and apparatus for loop detection and breaking are disclosed.

In a second aspect, a method for resolving a logical topology of a network is disclosed. In one embodiment, the physical network includes a plurality of devices, and the method involves: monitoring the physical network for a trigger event, the trigger event indicating a change to the physical network; identifying one or more confounding structures; determining a logical network topology, wherein the logical network topology quarantines the confounding structures of the physical network; and activating the logical network to provide a unidirectional and unconfounded network of the devices.

In one variant, the network is an A/V network adapted to utilize DisplayPort connections and protocols.

In another variant, the one or more confounding structures comprise a loop or a non-unique signal path.

In a further variant, the trigger event involves connection of a display device to the network, and the method is performed substantially automatically and without user intervention.

In yet another variant, the plurality of devices comprise a sink device and a source device, and the unidirectional and unconfounded network of the devices further includes a channel capable of providing at least one of capability and/or status information to be transferred from the sink device to the source device.

In still another variant, the source device is a master device, and the sink device is a slave device under control of the source. The source device may be used to control both: (i) the transmission of the at least one capability and/or status information between the source device and the sink device, and (ii) the higher level management of the display and network.

In a third aspect, apparatus adapted for connection to at least one other device within a computerized network is disclosed. In one embodiment, the apparatus is configured to resolve user-instigated malconfigurations, and includes: first logic to identify one or more confounding structures; second logic to determine a logical network topology, the logical network topology being effective to quarantine the confounding structures; and third logic to configure the logical network to provide a unidirectional and unconfounded network of devices.

In one variant, the first logic is configured to detect the one or more confounding structures upon connection or removal of one of the devices to the network, the detection being accomplished at least in part using one or more signals (e.g., Hot-Plug Detect (HPD) interrupt signal) carried over one or more pins of a connector by which the one device is connected.

In another variant, the apparatus is a laptop, desktop, or handheld computer, and the identification, determination and configuration are performed substantially automatically and without user intervention.

In another embodiment, the apparatus includes a processor; a storage device in data communication with the processor; at least one auxiliary communication channel capability useful for management and data control; and at least one computer program resident on the storage device. The program is configured to, when executed on the processor, detect at least one malconfiguration within the audio-visual device network to which the device is connected; use the at least one auxiliary channel capability to perform at least one of bus arbitration and messaging for topology resolution; and based at least in part on the at least one of bus arbitration and messaging, generate a logical topology having unique and finite path properties.

In one variant of this apparatus, the auxiliary channel capability is a bi-directional channel capability, and the network includes at least one master node and at least one slave node. The computer program is further configured to perform an arbitration process that delegates control responsibility from a master node to a slave node. For instance, the apparatus might act as the master node.

In another variant, the delegation involves: delegation of the control to a maximum of one slave node at any one time; and reacquisition of the control at the master node when the slave node relinquishes the control.

In a fourth aspect of the invention, a method of enabling the functioning of a network of devices connected in an otherwise at least partly inoperative configuration is disclosed. In one embodiment, the at least partly inoperative configuration has a plurality of possible logical mappings of physical topology, and the method includes arbitrating the plurality of possible logical mappings, the arbitrating comprising at least one of (i) bus arbitration and/or (ii) messaging for topology resolution, and selecting a single one of the possible mappings. The arbitrating and selecting precludes the network from failing in the at least partly inoperative configuration.

In a fifth aspect of the invention, a bi-directional signal interface adapted for use in a substantially unidirectional network is disclosed. In one embodiment, the bi-directional interface is used in conjunction with a DisplayPort-compliant apparatus. The bi-directionality allows for, inter alia, logical topographical resolution and passing media data and other communications upstream from “sink” devices that can create such media data or communications.

In a sixth aspect of the invention, a networking protocol adapted to utilize the foregoing bi-directional interface is disclosed. In one embodiment, the protocol is adapted to function cooperatively with an extant master/slave based messaging protocol (e.g., DisplayPort) so as to permit logical topological resolution, thereby making connection of devices within the network substantially “idiot proof”.

In a seventh aspect of the invention, an improved network comprising a plurality of devices (e.g., one or more sources, one or more branches, and one or more sinks) is disclosed. In one embodiment, the network is an A/V network, and the various devices (nodes) of the network are enabled for the aforementioned bi-directional communication protocol and logical topological resolution capability.

In an eighth aspect of the invention, a computer-readable apparatus is disclosed. In one embodiment, the apparatus includes a computer-readable medium containing a computer program, the computer program being adapted for loop detection and breaking and/or logical topological resolution.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1A is a logical block diagram illustrating a valid topology for a unidirectional network of component devices.

FIG. 1B is a logical block diagram illustrating one typical invalid topology for a unidirectional network of component devices, wherein an infinite signal path is created.

FIG. 1C is a logical block diagram illustrating another invalid topology for a unidirectional network of component devices, wherein multiple non-unique paths are created.

FIG. 1D is a logical block diagram illustrating a first physical topology for a unidirectional network of component devices, having a first logical topology

FIG. 1E is a logical block diagram illustrating the same first physical topology of FIG. 1D, having a second logical topology

FIG. 2 is a logical flow diagram of an exemplary embodiment of the generalized logical mapping process for resolving physical topologies in accordance with the invention.

FIG. 3 is a functional block diagram illustrating one embodiment of a unidirectional network component apparatus adapted to implement the unidirectional network management methods of the present invention.

FIG. 3A is a functional block diagram illustrating one embodiment of a unidirectional network sink component apparatus adapted to implement the unidirectional network management methods of the present invention.

FIG. 3B is a functional block diagram illustrating one embodiment of a unidirectional network source component apparatus adapted to implement the unidirectional network management methods of the present invention.

FIG. 3C is a functional block diagram illustrating one embodiment of a unidirectional network branch component apparatus adapted to implement the unidirectional network management methods of the present invention.

FIG. 4 is a functional block diagram illustrating one invalid topology for a unidirectional network of component devices, having been corrected using the methods of network arbitration and topology resolution of the present invention.

FIG. 5 is a functional block diagram illustrating one embodiment of a finite state machine (FSM) associated with a unidirectional port of the present invention.

FIG. 6 is a logical flow diagram of one exemplary embodiment of a procedure for a Control Node that is mapping a logical topology over a physical topology in accordance with the present invention.

FIG. 6A is a functional block diagram illustrating the arbitration of two previously unconnected unidirectional networks according to one embodiment of the invention.

FIG. 6B is a functional block diagram illustrating one embodiment of a finite state machine for bus arbitration according to the invention

FIG. 7 is a functional ladder diagram illustrating one embodiment of the messaging protocol implemented between the components of FIG. 4.

### DETAILED DESCRIPTION OF THE INVENTION

Reference is now made to the drawings, wherein like numerals refer to like parts throughout.

As used herein, the term “DisplayPort” refers without limitation to apparatus and technology compliant with “VESA DisplayPort Standard”—Version 1, Revision 1a dated Jan. 11, 2008; “VESA DisplayPort Panel Connector Standard”—Version 1.1 dated Jan. 4, 2008; “VESA DisplayPort™ PHY Compliance Test Standard”—Version 1 dated Sep. 14, 2007; and/or “VESA DisplayPort™ Link Layer Compliance Test Standard”—Version 1.0, dated Sep. 14, 2007, as well as so-called “Mini DisplayPort” technology described in the Draft VESA DisplayPort Version 1.2 Standard, each of the foregoing being incorporated herein by reference in its entirety, and any subsequent revisions thereof.

### Overview

The present invention discloses, inter alia, methods and apparatus for resolving valid networking structures for impromptu or ad hoc networks of audio-visual (A/V) components. In one embodiment, the networks are checked for problematic or “confounding” structures such as loops and non-unique paths between endpoints. Apparatus and methods are also disclosed which provide for network arbitration, and topology resolution. Furthermore, while the network itself is generally unidirectional during functional operation, each component can utilize an extant master/slave channel to perform network arbitration and topology resolution during at least an initialization phase of a topological change.

In one embodiment, the invention also enables networks having automatic resolution mechanisms to compensate for unintentional user misconfiguration, greatly aiding in overall system robustness. For example, in one embodiment, given multiple possible logical mappings of a physical topology, the network automatically arbitrates to one, and only one, mapping, rather than failing in an indeterminate (and hence unresolved) configuration. The present invention allows a user of relatively little skill to operate (to at least some functional degree) complex systems in a desired manner, even when the systems are connected improperly. Hence, the invention makes the formation of an A/V device network or topology largely “idiot proof” in common parlance.

In one variant, auxiliary bi-directional channel connections currently used for management and data control are leveraged to provide topology management of a unidirectional network. Specifically, auxiliary channels are disclosed which activate additional functionalities, when triggered by e.g., the detection of one or more neighboring networked devices being added to or subtracted from the network. The disclosed additional functions may include bus arbitration and/or messaging for topology resolution. Furthermore, the disclosed embodiments for bus arbitration and topology resolution are optimized in the present invention for use within a unidirectional network, and in particular audio-visual networks including those adapted for computer and consumer electronics, thereby allowing for broad commercial implementation.

In yet another aspect, apparatus and methods are disclosed to generate a logical topology with unique and finite path properties. In one embodiment, the logical topology is overlaid onto the detected physical topology, thereby providing network functionality in an otherwise inoperable network configuration.

In another aspect, apparatus and methods are disclosed which provide an arbitration mechanism for delegating control responsibilities from a master node to other nodes in the system (a maximum of one node being given a specific control responsibility at any one time), and for reacquiring control at the master node when the other node relinquishes control. The arbitration mechanism is used in certain embodiments to ensure only one node is allocated network control at a time.

### DETAILED DESCRIPTION OF EXEMPLARY EMBODIMENTS

Exemplary embodiments of the present invention are now described in detail. While these embodiments are primarily discussed in the context of a Video Electronics Standards Association (VESA) DisplayPort audio/visual (A/V) component network, it will be recognized by those of ordinary skill that the present invention is not so limited. In fact, the various aspects of the invention are useful in any unidirectional network that can benefit from the dynamic adjustment of its topology (e.g., loop healing or path reconfiguration) as is disclosed herein.

### Unidirectional Network Properties and DisplayPort 1.2 Addressing—

Unidirectional networks of the type described herein have specific properties, some of which provide useful assumptions and/or limitations to the system. Source elements uniquely generate at least one data stream. A sink refers to a device or element which consumes at least one data stream. Unlike traditional bi-directional networks which support dynamic routing structures, unidirectional networks also have fixed “upstream” and “downstream” port directions. An upstream port receives at least one input data stream. A downstream port transmits at least one output data stream. Elements within the network may have any combination of upstream or downstream ports. Unidirectional networks may also utilize concentrator or multiplexer nodes and splitter or de-multiplexer nodes. While generally used in the context of converting a single first stream to a plurality of second streams or vice versa, it is appreciated that instances of these elements may also convert any number of first streams to a greater number of second streams, and vice versa.

The incipient DisplayPort Version 1.2 Standard introduces an addressing mechanism to flexibly permit multiple DisplayPort source devices to communicate with multiple DisplayPort sink devices over a network of source, sink and branch devices. To these ends, a discovery mechanism must establish an address for each sink device. The addressing mechanism adopted for DisplayPort 1.2 uses concatenated relative addresses, which simplifies the configuration process. Unfortunately, however, this addressing mechanism, and its associated discovery process, assumes that there is either one unique and finite path from each source to each sink, or no such path at all.

This assumption can be problematic, since anecdotal evidence suggests that consumers of A/V products may not necessarily understand or comprehend network topology when setting up custom systems. Moreover, uninformed users may feel the temptation to connect a cable to every port on the device, preferring to err on the side of “caution”. For devices which are intended for a wide array of possible networking configurations, the unintentional or incorrect connection of one or more components may be disastrous if left unhandled.

In order to enhance “user experience” (simplicity and robustness being a subset thereof), it is desirable not to require users, even knowledgeable ones, to consider the various intricacies of different physical topologies. The present invention enables an uneducated user to modify an existing network incorrectly (i.e., change the physical topology), and the system responsively ascertains if there are any logical problems with the new physical topology (e.g. infinite loops, non-unique paths resulting from too many cables being connected, etc.), and adjusts accordingly.

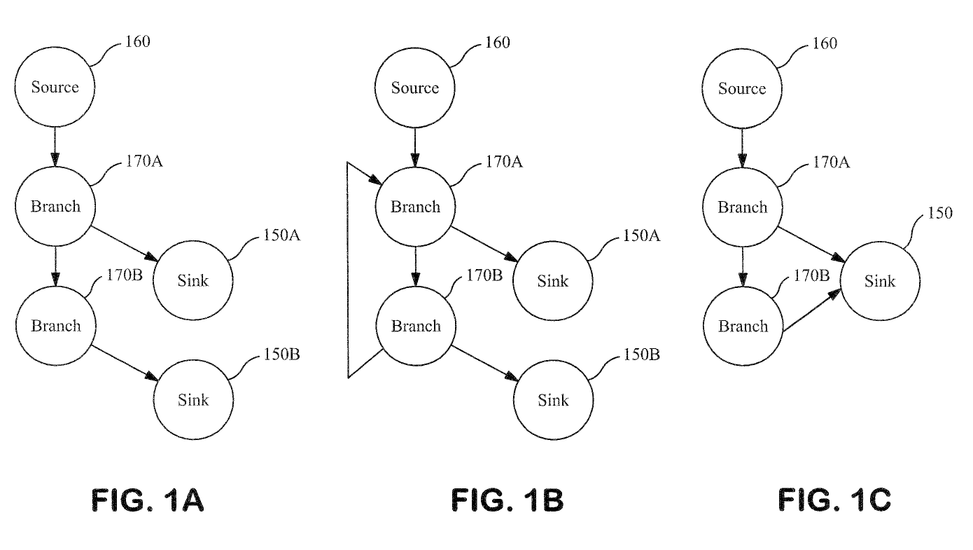

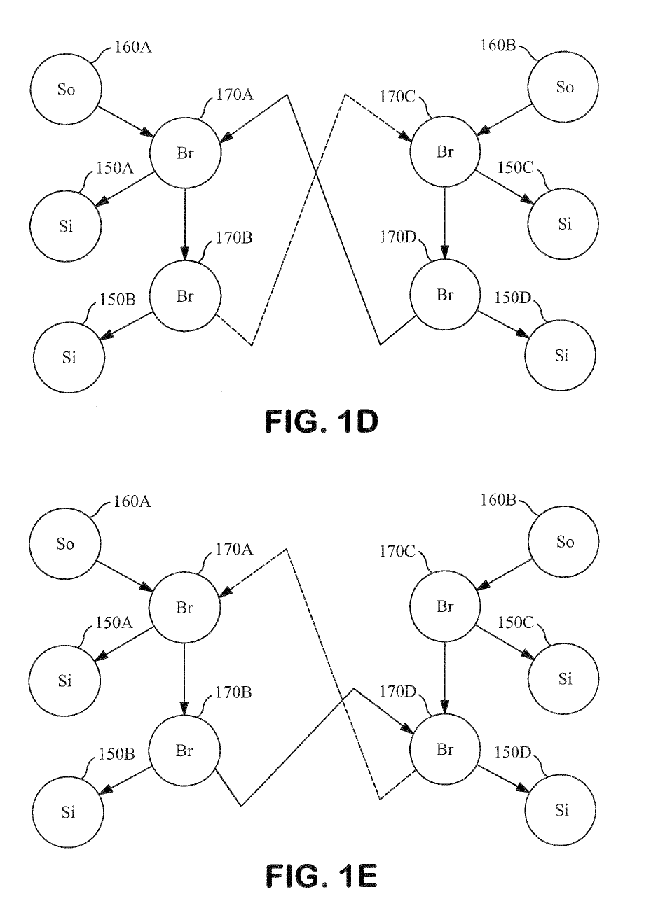

FIG. 1 A shows an exemplary embodiment of one arbitrary topology of a DisplayPort network of devices, having a unique and finite path from the source 160, through branches (e.g. 170A, 170B) to each sink (e.g. 150A, 150B).

In contrast to FIG. 1A, FIG. 1B shows an exemplary embodiment of an invalid or “confounding” topology. Consider an addressable message that originates from the source 160 and is sent to the first branch 170A. The first branch 170A forwards the message to its sink 150A, and the second branch 170B. The second branch forwards the message to its sink 150B, and back to the first branch 170A. Thus, FIG. 1B demonstrates how an infinite loop is created as a first branch 170B loops back to feed its predecessor branch 170A. In FIG. 1C, another exemplary embodiment of an arbitrary invalid topology is shown. This topology is invalid because two different, but not-unique paths exist between the source 160 and the sink 150. The first path consists of the source 160, a first branch node 170A, and the sink 150. The second path consists of the source 160, the first branch node 170A, the second branch node 170B, and the sink 150. Accordingly, any messages sent from the source node 160 to the sink node 150 will be duplicated.

Additional complications may arise in instances where a physical topology (i.e. physical interconnection or architecture of the network) has multiple logical topologies (i.e. functional or hierarchical interrelationships of the components) associated with it. For example, FIG. 1D illustrates a first physical topology and a first possible logical topology. In FIG. 1D, branch 170D logically connects to branch 170A, and branch 170B is physically connected to branch 170C. The link between branch 170B and 170C has been quarantined to support a valid logical topology. FIG. 1E illustrates the same physical topology and a second possible logical topology i.e. the link between 170B and 170C is connected, and the link between 170A and 170D is quarantined.

The processes of arbitration and “loop healing” described herein robustly handles invalid architectures (especially to address user misconfiguration as shown in FIGS. 1B-1E) which often result from user misconfiguration. Specifically, the disclosed methods and apparatus quarantine invalid or ambiguous portions of a physical topology. A “logical” topology with unique and finite path properties is formed and overlaid or “mapped” onto the physical topology (that may contain invalid structures). In the absence of loops or other confounding structures the logical and physical topology are identical.

In addition to resolving invalid network structures, one embodiment of the present invention additionally arbitrates bus access without requiring any device or system to “second guess” the user's true intent. Improper connections are automatically resolved by low level software and hardware intelligence, without any requirement for high level application software intelligence. Furthermore, this disclosed embodiment is not disruptive to ongoing network operation, and minimizes interruptions to existing traffic; existing active connections are not quarantined.

Lastly, it is appreciated that robust behavior may be favored over complexity. In some use cases, a higher level software application may be operatively coupled to the invention enabled system to display a graphical representation of the network to the user for correction. Thus, in such scenarios, a guaranteed minimum functionality takes precedence over topology resolution (even when incorrect).

### Methods—

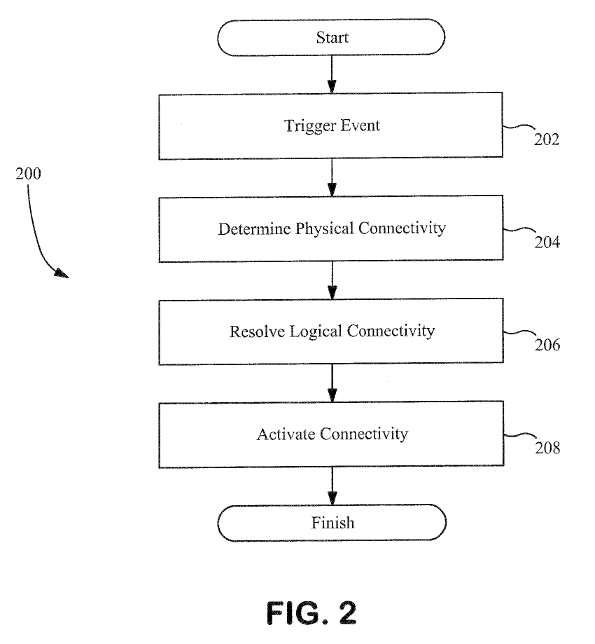

FIG. 2 depicts one embodiment of the aforementioned network resolution procedure 200 for implementation by a network of components. When a new connection is added to the bus topology, the resolution procedure tests the new connection. If several connections are made “simultaneously” then an arbitration mechanism tests each new connection (for instance, one at a time). Each connection is tested for loops (or similar problematic structures), and quarantined if a loop is found, or activated if a loop is not found). When any connection is disconnected, then all the quarantined connections must be retested to see if they were fixed.

From a “system-wide” level, the individual nodes act substantially autonomously; there is very little if any coordination between nodes. In fact, in certain embodiments no other node is aware that testing is initiated by other nodes. The involvement of other nodes is limited to message passing, assisting with arbitration and responding to direct commands from the testing node (e.g., ATTACH, DETACH, etc.). In other embodiments, a centralized node may retain nominal control, but may not be directly involved in testing.

In some cases, multiple nodes may contend for bus access. Accordingly, bus arbitration methods are disclosed to determine which contending ports are enabled or disabled for testing.

The primary operative elements as described with respect to the methodology of FIG. 2 are one or more source endpoints, one or more sink endpoints, and optionally one or more branching elements. The network resolution procedure 200 is now described in greater detail.

At step 202 of the method 200, the network of elements is triggered to assess or re-assess the physical connectivity of one or more constituent nodes. Responsive to the trigger event, all devices connected to the network enter a test mode or safe mode (e.g., in safe mode, a maximum of one element is allowed transaction activity at a time). In one embodiment, the safe or test mode encompasses only the auxiliary network functionality. In an alternate embodiment, the safe or test mode encompasses both the auxiliary and unidirectional network functionality.

A variety of different events or conditions can cause the aforementioned trigger. In one embodiment, an indicator signal may trigger the re-assessment of the physical topology. For instance, changes to the physical topology may be signaled with a Hot-Plug Detect (HPD) interrupt signal. The Hot-Plug Detect interrupt signals, for example, the addition of a new device to the network. The Hot-Plug Detect interrupt may also signal the removal of a known or already mapped device.

In another embodiment, a software application or routine may request a search of all devices on the current network (e.g., a user- or software-prompted event), such as upon power-up of a particular device. As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment. For example, a device having multiple ICs internal to the device which is powered on may trigger the assessment. In another example, a network of devices connected by cables may be powered on simultaneously or roughly simultaneously, thus triggering the assessment (once the network has initialized, additional devices powering-on may be handled essentially as hot-plugged events).

In an alternate embodiment, the triggering event may be initiated by polling software. For instance, a software daemon running in the background of one or more elements periodically reviews the devices connected to the network, when a change is detected, the polling software triggers an assessment of the physical topology. The software daemon might run continuously, or according to a predetermined schedule. As another alternative, the software daemon is triggered by a higher-layer application process.

Any number of other scenarios for triggering a topology assessment will be recognized by those of ordinary skill given the present disclosure.

At step 204, the physical connectivity of one or more nodes of the network is determined. In one embodiment, multiple elements of the network perform a topological test. In the exemplary embodiment, only one node on the net conducts topology test operations at a time. Accordingly, exemplary topological determination arbitration procedures are described in greater detail subsequently herein.

In an alternative embodiment, the physical topology of the entire network is known via other mechanisms. For instance, the topology may be sent in a higher layer software message or may comprise pre-stored data. One or more elements within the network topology may receive or access a node structure identifying at least a subset of its network. A node structure may comprise as little as the neighbors to the immediate upstream and downstream of the element, or alternatively, more detailed or comprehensive network topological information.

It will be appreciated that the entire topology of the network may be unknown to one or more operative elements in certain embodiments. For instance, as is illustrated in FIG. 1B, it may be sufficient for the first branch 170A to determine or know that one of its downstream ports includes the second branch 170B, and one of its upstream ports includes that same branch 170B (i.e., a loop exists), irrespective of the particular sources and sinks connected elsewhere in the network. In fact, in one aspect of the present invention, each device resolves its behavior without any comprehensive overview of the network. Instead, the device resolves its final connectivity based only on the devices physically connected on its various ports.

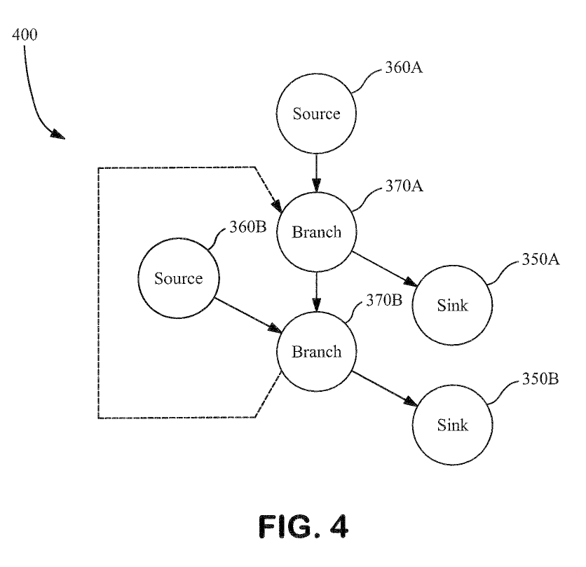

At step 206, elements detecting one or more invalid structures within the network assume a valid configuration; which when taken system wide, resolves to a single logical topology. In one exemplary embodiment, each element can determine its resolution routing for confounding structures. Each affected element may quarantine its upstream element (see, for instance, the discussion of FIG. 4 provided herein, wherein the quarantine is imposed on an upstream or input port on the first branch of the invalid configuration of FIG. 1B in order to resolve the issue). Alternatively, each affected element may quarantine its downstream element.

It is noted that in unidirectional network applications, there may be no substantial difference between these two alternatives, as long as each node within the network is standardized to remain consistent throughout (e.g., all quarantine downstream variants, or all quarantine upstream variants). Accordingly one variant of the method applies such logic.

Finally, at step 208, the affected nodes of the network activate their resolved connections for service. In one embodiment, each topological structure is activated independently. Alternatively, multiple logical trees may be activated simultaneously (such as where several activation requests are received and processed simultaneously).

Furthermore, while combinations of activation timing are possible (e.g. a first portion of the network may be activated independently, and a second portion of the network may be activated simultaneously), measures should be taken to ensure that the activation process does not inadvertently create invalid structures.

Although it is appreciated that the present invention does not require a centralized device to control activation, in some embodiments a centralized device may be used to control at least a subset of the logical topologies (e.g., according to a prescribed sequence). For example, a complex network may have a first portion affected by the addition or removal of a node, and a second portion which remains unchanged. To minimize unnecessary overhead, a centralized node for the second portion may be designated to control activation of the entire second portion. When the first portion of the network has determined its resolution, the centralized node activates the second portion of the network simultaneously.

During activation the auxiliary channel and the unidirectional channels exit safe mode, and initialize links for normal operation. During initialization, operations such as device discovery, addressing, and network resolution can occur across the new system-wide logical network topology. The resolved structure may differ from what the user intended, but will remain minimally functional. In some use scenarios, a higher level software application may display the resultant resolved topology to the user.

Simple logical topologies comprise a single source node, a collection of one or more sink nodes, and optional branching nodes. One exemplary logical topology would be a “tree” or “trunking” structure. As previously noted, in the absence of any confounding structures (e.g. loops, duplicate paths, etc.), the logical and physical topology should be identical. Degenerate topologies are described herein for completeness, but are not “functional”, and would abort the method 200 (at least in so far as it related to the degenerate or unsupportable devices).

### Apparatus—

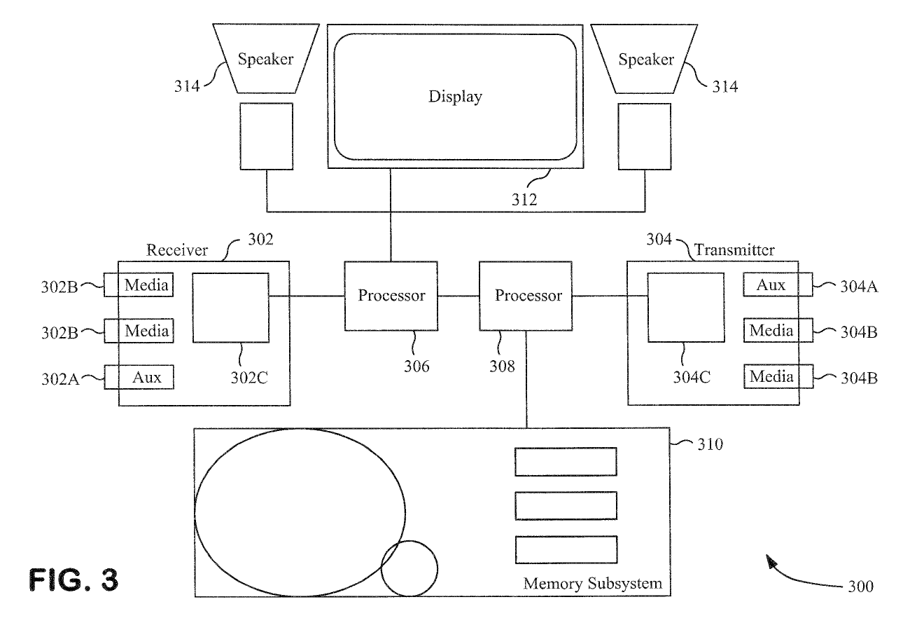

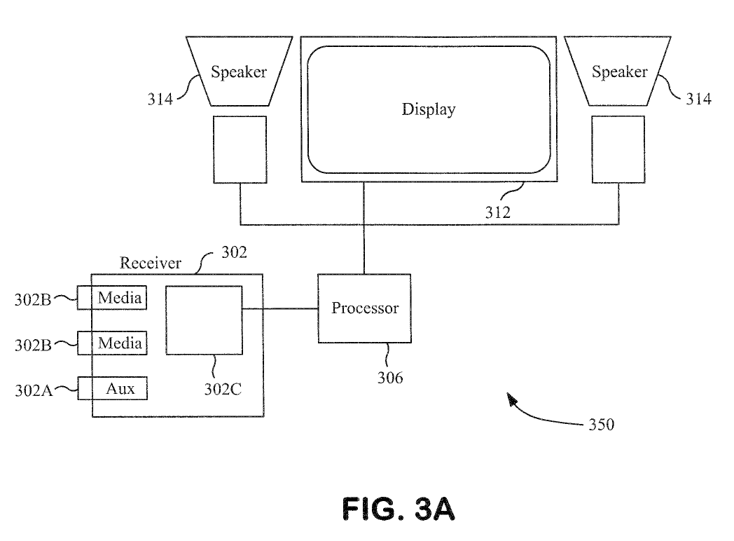

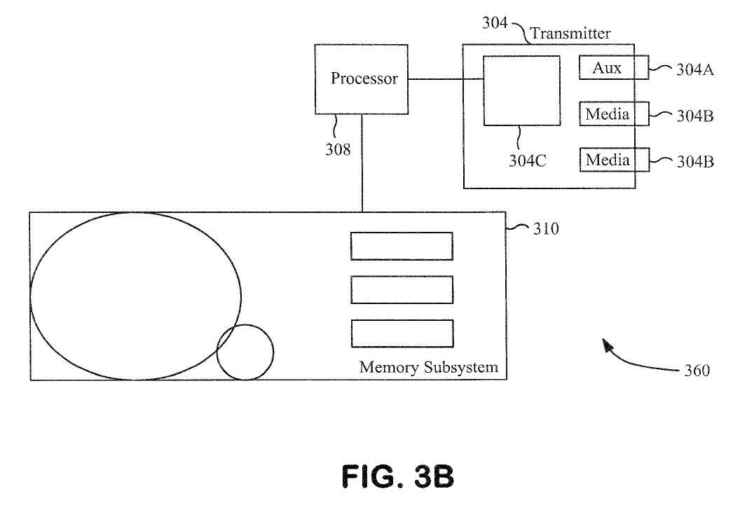

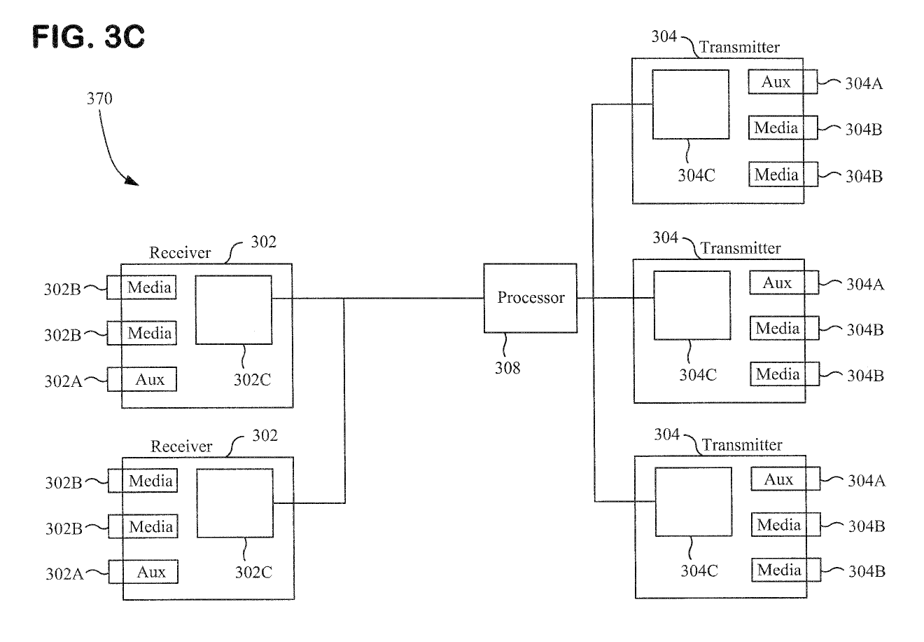

Referring now to FIG. 3, an exemplary A/V apparatus 300 having unidirectional networking capabilities is depicted. While a specific device configuration and layout is shown and discussed, it is recognized that various other implementations may be readily utilized by one of ordinary skill given the present disclosure, the apparatus 300 of FIG. 3 being merely illustrative of the broader principles.

The illustrated apparatus 300 of FIG. 3 includes an upstream plurality of ports and corresponding receiving elements (e.g., receiving interfaces, transceiver interfaces) 302, a downstream plurality of ports and corresponding transmitting elements (e.g., transmitting interfaces, transceiver interfaces) 304, one or more digital processing elements 306, 308. Also included are memory elements (e.g., storage devices) 310, and audio 314 and video 312 elements. As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

It will be appreciated that not all elements are required in a single device for operation within a network community. For instance, a device only capable of source operation would not require upstream ports 302, or certain audio 314 or video 312 elements. Conversely, a sink device may not require downstream ports 304. Moreover, the “receiver” 302 and “transmitter” 304 elements may, in one embodiment, comprise transceivers capable of both transmission and reception if desired.

As shown in FIG. 3, the upstream plurality of ports and associated receiving elements 302 includes one or more upstream auxiliary channel 302A, one or more upstream media ports 302B, and receiver apparatus 302C (e.g. multiplexing switches, reception logic, clock recovery circuitry, etc.). As used herein, the term “circuitry” refers to any type of device having any level of integration (including without limitation ULSI, VLSI, and LSI) and irrespective of process or base materials (including, without limitation Si, SiGe, CMOS and GaAs), as well as discrete components such as resistors, diodes, capacitors, inductive reactors, and any combinations of the foregoing. In one exemplary embodiment, the auxiliary channel 302A is bi-directional and carries management and device control data, and the upstream media ports 302B minimally comprise receivers for unidirectional data lanes, and use of an embedded clock. The receiver apparatus 302C monitors and selectively enables and disables the auxiliary 302A and media 302B ports. In certain embodiments, the receiver apparatus 302C may be adapted to utilize a packet-based unidirectional network protocol, such as the DisplayPort protocol previously described herein.

Similarly the downstream plurality of ports and associated receiving elements 304 comprise one or more downstream auxiliary channel 304A, one or more downstream media ports 304B, and transmitter apparatus 304C (e.g. demultiplexing switches, transmission logic, clock embedding circuitry, etc.). In one exemplary embodiment, the auxiliary channel 304A is bi-directional and carries management and device control data, and the downstream media ports 304B minimally comprise transmitters for unidirectional data lanes, and inclusion of an embedded clock. The transmitter apparatus 304C monitors and selectively enables and disables the auxiliary and media ports. As with the receiver, the transmitter apparatus 304C may be adapted to utilize a packet-based unidirectional network protocol (e.g., DisplayPort).

Both upstream 302 and downstream 304 ports enable their respective media ports during unidirectional network operation. During network “safe mode” as previously described, the media ports are disabled. In one embodiment, the auxiliary ports are enabled during network “safe mode”, and remain enabled during network operation, such as to pass information upstream as it is periodically received or updated, or stream media upstream (see discussion below). The processing elements 306, 308 may comprise one or more of central processing units (CPU) or digital processors, such as a microprocessor, digital signal processor, field-programmable gate array, RISC core, or plurality of processing components mounted on one or more substrates. As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

The processing subsystem is tightly coupled to operational memory, which may include for example SRAM, FLASH and SDRAM components. The processing subsystem may also comprise additional co-processors, such as a dedicated graphics accelerator, network processor (NP), or audio/video processor. As shown processing elements 306, 308 are discrete components, however it is understood that in some embodiments they may be consolidated or fashioned in a SoC (system-on-chip) configuration.

The processing element 306 is adapted to receive one or more media streams from the upstream apparatus 302 for processing for media displays such as a video display 312, or audio speakers 314. As used herein, the term “display” refers without limitation to any visual display device including e.g., LCD, plasma, TFT, CRT, LED, incandescent, fluorescent, and other types of indicator or image display technologies. Processing element 306 may preferentially comprise graphics processors, applications processors, and or audio processors. In “thin clients” the processing element 306 may be significantly reduced in complexity and limited to simple logic, or in extreme cases altogether non-existent.

The processing element 308 is adapted to provide one or more media streams to the downstream apparatus 304 for transmission to other networked devices. In certain embodiments, the processing element 308 may receive one or more media streams from upstream data ports (e.g. as when operating as a branching or hub device). Alternatively, the processing element 308 may generate a media stream from memory subsystems, or media stream capture apparatus (e.g. video camera or microphone apparatus which are not shown).

Accordingly, the processing subsystem 308 may be connected to a memory subsystem 310 comprising memory which may, for example, be hard disk drives, or solid state memory (e.g. RAM, FLASH) type components. The memory subsystem 310 may implement one or a more of DMA type hardware, so as to facilitate data accesses, as is well known in the art.

The audio-visual system may comprise any number of well-known audio 314 and/or visual 312 components (including, without limitation: displays, backlights, such as vocoders, microphones, and speakers). Note that while a unidirectional “source-to-sink” model is utilized for most media delivery, the present invention may also utilize media flow piggybacked onto the reverse or upstream (auxiliary) channels, such as where a microphone co-located with a user display receives user-generated audio (speech, etc.), digitizes it, and sends it back upstream to the source device via the auxiliary channels. In one embodiment, the audio-visual system may be configured to source data to the processing subsystem 306, 308. Alternatively, the data may be sourced to the downstream transmission port 304. This embodiment may utilize common “output” A/V devices, such as a video camera for video capture, and one or more microphones for audio capture.

It is recognized that in certain hardware or software applications, one or more of these components may be obviated. For example, component audio systems are typically implemented with only a single, or subset of the audio channels delivered to each audio component (e.g. subwoofer, and stereo surround channels). Similarly, some video components are not commonly used with audio inputs; e.g. projection equipment. In fact, in most typical networks for A/V processing, elements will generally be substantially limited to one or two functional capabilities.

Accordingly, referring now to FIGS. 3A, 3B, and 3C, representative embodiments of A/V apparatus having limited functionality are shown. Each of the illustrated apparatus is optimized for certain functionality. Such limited functionality apparatus may be advantageously used within “thin” client environments; e.g., in low-cost consumer applications, or in mobile devices where space and power conservation are at a premium.

FIG. 3A illustrates exemplary sink apparatus 350 comprising an upstream plurality of ports and corresponding receiving elements 302, a processing element 306, and audio 314 or video 312 elements. Common exemplary embodiments of sink apparatus include displays, monitors, speakers, etc. Such sink components consume one or more media streams, for example a 2 (two) channel speaker consumes 2 (two) audio streams. Some sink elements can also be network masters. For example, one common use scenario illustrating a sink mastered network includes a laptop receiving a video and audio stream from a web camera and microphone, respectively.

FIG. 3B depicts exemplary source apparatus 360 comprising a downstream plurality of ports and corresponding transmitting elements 304, a processing element 308, and memory subsystem 310. Common exemplary embodiments of source apparatus include computing devices, video cameras, microphones, etc. Such source components generate one or more output media streams. Some source components can also be network masters. For example, one common use scenario illustrating a source mastered network includes a server which provides audio and video streams to speakers and monitors, respectively.

FIG. 3C shows exemplary branching apparatus 370 comprising a downstream plurality of ports and corresponding transmitting elements 304, an upstream plurality of ports and corresponding receiving elements 302, and optionally a processing element 308. Common exemplary embodiments of branch apparatus include hubs, computing devices, etc. Such branch components can concentrate or multiplex incoming streams and split or de-multiplex outgoing streams. Branch components are generally “thin” clients; however some branch elements can also be network masters. For example, one common use scenario illustrating a branch mastered network includes a mixing table receiving a plurality of audio streams which are redistributed to a number of audio speakers.

It will be readily appreciated by those of ordinary skill that different combinations and/or variations of the foregoing can be made depending on the desired application and performance attributes.

### Example Operation—

One exemplary implementation illustrative of the general concepts of the invention is now described with respect to the network topology 400 of FIG. 4. The application specific elements (see FIG. 3A, FIG. 3B, FIG. 3C) within the network 400 execute the aforementioned mapping procedure (see FIG. 2).

FIG. 4 depicts a simple DisplayPort network 400 includes an exemplary first source 360A, second source 360B, first branch 370A, second branch 370B, first sink 350A, and second sink 350B. In this example, the second branch node 370B is connected (e.g., by a user plugging in a cable) to the first branch node 370A, causing a Hot-Plug Detection (HPD) event.

When the new connection is detected, the topology 400 is tested to see if a loop or other misconfiguration has resulted. If a misconfiguration has been detected, then the new connection is quarantined and is not used. In this example, an infinite loop has been created between the second branch 370B and the first branch 370A, and is subsequently detected. The infinite loop is then broken on the newly connected upstream port of the first branch 370A.

During the testing procedure, each node maintains its active media channels, and utilizes the auxiliary channel (FIG. 3) to provide bi-directional communications. During this bi-directional stage, various precautions (e.g. arbitration) must be observed to ensure that proper network control is maintained. The new connection is inactive, and remains disabled until loop testing is concluded.

Only after testing is complete, and a decision is made to use the new connection, is the new connection “activated” and, in the case of downstream facing ports, an HPD interrupt propagated upstream to the first 360A and second 360B sources. Discovery and configuration then takes place. Testing a new connection takes place in parallel with, and without disrupting, normal operation of the existing topology. At the conclusion of the testing phase, the auxiliary channels continue with normal functions for management and device control transport.

Conversely, when a disconnection is detected (e.g. user disconnects Branch 370A from Branch 370B), the previously quarantined connections are re-evaluated to see if they can now be used without forming a loop. If the testing is performed as the result of a disconnect, then there will be one HPD interrupt for the disconnect event, and zero or more HPD interrupts depending on whether subsequent testing results in zero or more previously quarantined connections being reactivated.

It will be appreciated that not all implementations of the generalized procedure are deterministic. One physical topology may have many different possible logical topologies (see FIGS. 1D and 1E herein), and different paths may be created and broken on a case-by-case basis. For some implementations, this may have an impact on “reachability” (e.g. the paths between the source and the sink). Thus, some systems may require additional testing when multiple new connections are physically made simultaneously or rapidly one after another.

An inhibiting or stepwise function must be employed, if multiple simultaneous or sequential connections are made. The testing and detection process of FIG. 2 is conducted in an orderly and sequential (“lock step”) fashion so as to preclude timing issues from producing erroneous end results. For example, if two connections are tested simultaneously, then the testing of each connection may return a false negative response. When both connections are activated, a loop is formed, breaking the system. Thus, the network of nodes of this embodiment is restricted to allow only a single Control Node to test the network at any time.

Exemplary Port State Machine

In one exemplary embodiment of the invention, each node of the system 400 has a state machine (e.g., finite state machine or FSM) associated with each of its upstream and downstream ports. At a high level, the state machines each comprise a logical process that imposes certain logic and rules on the operation of its associated port. The state machine can be rendered in software, firmware, hardware, or any combination thereof, as is well known to those of ordinary skill in the art.

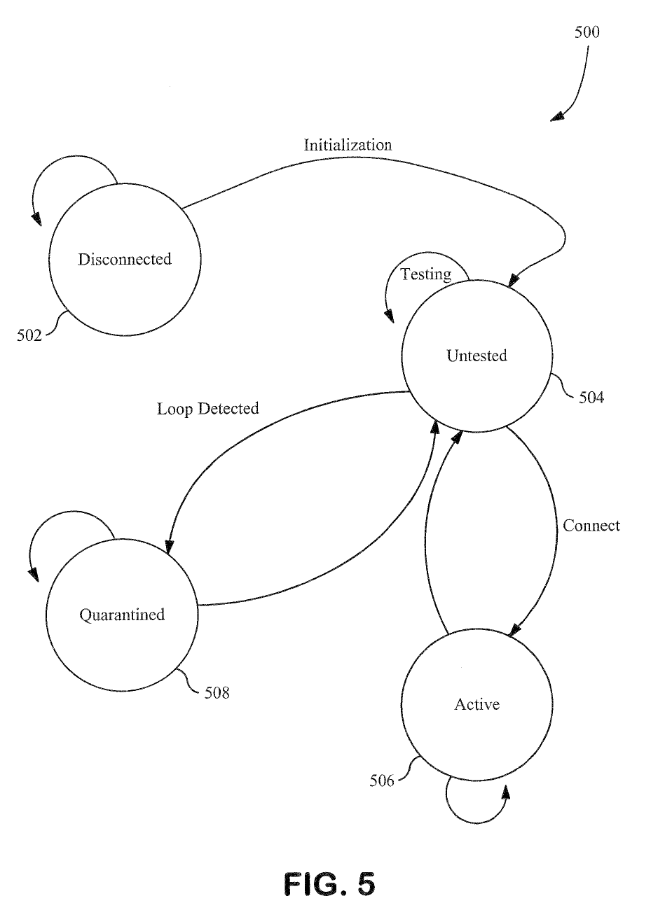

One exemplary state machine useful with the invention is shown in FIG. 5. The state machine 500 includes 4 (four) states: DISCONNECTED 502, UNTESTED 504, ACTIVE 506, QUARANTINED 508. Each port will always be in one of these states. Each node powers up its state machine 500 in state DISCONNECTED 502. Furthermore, any port which is disconnected from its partner port will automatically transition to state DISCONNECTED 502.

At state DISCONNECTED 502, no physical connection is detected, and the port is inactive. When a cable is attached to a DISCONNECTED 502 port (and its corresponding peer port which is also in the DISCONNECTED 502 state), the state machine 500 is signaled to transition to state UNTESTED 504.

In a common implementation of a DisplayPort device, insertion of a cable between a downstream facing port and an upstream facing port results in both ports detecting the physical connection. The downstream facing port applies a bias signal to the auxiliary channel signals which is detected by the upstream facing port. A Hot Plug Detect (HPD) signal line is held to a logic level LOW (e.g., via pull-down resistor, etc.) at the downstream facing port. The upstream facing port drives the Hot Plug Detect (HPD) signal line to logic level HIGH when it is connected. The corresponding logic level is detected by the downstream facing port. Thus, the DISCONNECT 502 state corresponds roughly to the lack of a bias level on the auxiliary channel signals and HPD logic level LOW (although some exceptions exist during certain transient intervals when HPD may be driven LOW for unrelated reasons, despite the existence of a physical cable connection).

At state UNTESTED 504, a physical connection has been detected but the port is waiting to be activated or quarantined as a result of loop testing. Multiple ports on a single node can be in this state. Furthermore, multiple ports on multiple nodes can also be (and usually are) in the UNTESTED 504 state. UNTESTED 504 states must occur in pairs at either end of a physical connection. Thus, if one downstream facing port is in the UNTESTED 504 state, its conjoined upstream facing port must also be in the UNTESTED 504 state. Once testing has been completed within the UNTESTED 504 state, each physical connection of the node is either valid or invalid. In one exemplary embodiment, the testing of the connection is controlled by the upstream facing port. If the test is successful (e.g., no loop is detected), then the upstream facing port negotiates a connection via typical connection initialization procedures (e.g. sending an ATTACH message to the peer downstream-facing port). Both of the ports then transition into the ACTIVE 506 state. If the test is unsuccessful, then the upstream facing port transitions to the QUARANTINED 508 state (both upstream and downstream ports transition). In other embodiments, the testing of the connection could be equivalently controlled by the downstream facing ports.

Each node eliminates any locally identified confounding structures; the resultant logical topology is presumed to be valid for unidirectional network operation. For valid port connections, the port state machine transitions to state ACTIVE 506, and the port proceeds with operation. Conversely, invalid ports are transitioned to QUARANTINED 508, which disables the port from operation. Note that quarantined ports will occur in pairs (if one downlink port is in the QUARANTINED state 508, its conjoined uplink port must also be in the QUARANTINED state 508).

### Exemplary Loop Testing—

An exemplary embodiment of the loop testing and resolution stage is now described in greater detail. During loop resolution, each node only passively responds to loop testing commands (per UNTESTED 504 state). Care has to be taken to ensure that connections are tested one at a time. It is possible that multiple nodes within the network each have one or more upstream ports in the UNTESTED 504 state. Accordingly, the loop testing and resolution stage is only performed by the single Control Node (the current Control Node is determined with an arbitration procedure) on its upstream nodes.

The Control Node performs a “loop test”. At the conclusion of its loop test, the Control Node releases control of the network. This allows another node to become the next Control Node. The designation of Control Node responsibility is decided by an arbitration process. When all nodes have concluded their loop test, all confounding structures within the physical topology (including both active and quarantined ports), have been determined and resolved. The following terms are used throughout, in reference to the various functions and elements of loop testing and resolution:

TEST_VALUE: a hopefully unique identifier (HUID) which is probabilistically unique. The TEST_VALUE can come from e.g., random number generator or other such device (e.g., Linear Feedback Shift Register (LFSR), free running counter, etc.).

LOOP_TEST_DATA (LTD): an eight (8) bit value comprising a six (6) bit TEST_VALUE, a single mode bit (M) and a single generation bit (G).

LOOP_TEST_PROBE (LTP): a probe message comprising LOOP_TEST DATA sent on all active ports of the Control Node, and repeated by the receiving nodes to each of their respective active ports. The LOOP_TEST_PROBE is only initiated by the current Control Node of the network.

LOOP_TEST_SYMBOL (LTS): a LOOP TEST DATA value sent continuously by a node on a downstream port that is in the UNTESTED state. Each node receiving a LOOP_TEST_PROBE, forwards a LOOP_TEST_SYMBOL containing the LOOP_TEST_DATA from that LOOP_TEST_PROBE to all of its downstream ports that are in the UNTESTED state (i.e. propagating the LOOP_TEST_SYMBOL downstream).

HOLDING_REGISTER (HR): a holding register local to each node, which stores the LOOP_TEST_DATA in the last LOOP_TEST_PROBE received.

After the Control Node initiates a LOOP_TEST_PROBE, every downstream facing node will forward the LOOP_TEST_PROBE. The Control Node monitors its upstream test ports for duplicate LOOP_TEST_SYMBOLS (LTS) received within a designated TEST_TIMER (TEST_INTERVAL) time value. If a loop is present, a duplicate LOOP_TEST_SYMBOL will be received on a node's upstream port. If a loop is not present, the received LOOP_TEST_SYMBOL will typically have a different LOOP_TEST_DATA. In some rare cases, a received LOOP_TEST_SYMBOL will have the same LOOP_TEST_DATA by random chance. Accordingly, even if the Control Node receives a LOOP_TEST_SYMBOL with the same LOOP_TEST_SYMBOL, the Control Node will select a new LOOP_TEST_DATA value and repeat the test multiple times. After several (e.g. twelve (12)) failed attempts (i.e. the received LOOP_TEST_SYMBOL contained the same LOOP_TEST_DATA as that transmitted in the LOOP_TEST_PROBE), the Control Node assumes the connection is a loop, and places the port in quarantine.

The above-referenced LOOP_TEST_DATA is now discussed in greater detail. In the exemplary embodiment, LOOP_TEST_DATA includes two special purpose bits, M and G. M performs basic control and loop test propagation functions. G enables optimized loop testing.

The M bit signals two states: TEST and ATTACH_IN_PROGRESS. During a loop test (TEST), each node tests its downstream ports by examining each hop. For an untested hop, the M bit of LOOP_TEST_DATA is set to TEST. Once a connection has been verified, the M bit is set to the second state; i.e., ATTACH_IN_PROGRESS. Accordingly, several events automatically set the M bit to TEST: (i) power on, (ii) test reset (including completion of testing), or (iii) receipt of a LOOP_TEST_PROBE with the mode set to TEST, or (iv) the receipt of any non-LOOP_TEST_PROBE packet during loop testing.

Each node will set the M bit to ATTACH_IN_PROGRESS in only two (2) cases: (i) if the node is the Control Node and it has determined that placing the test port in the ACTIVE state 506 (per FIG. 5) will not create a loop, or (ii) if the node receives a LOOP_TEST_PROBE with this mode set.

While it is assumed that there is only one Control Node, in some uncontrollable circumstances, multiple nodes may attempt to test a network. For example, two previously unconnected (but fully functioning) networks could be connected. Simultaneously each network will have designated a Control Node for testing the new connection. Accordingly, if any node receives another LOOP_TEST_SYMBOL with the mode set to ATTACH_IN_PROGRESS, then the node should assume that a connection is about to be made active on the subnet at the other end of the connection.

Furthermore, received ATTACH_IN_PROGRESS messages will necessarily override any concurrent node testing. If a Control Node were to receive an ATTACH_In_PROGRESS, and continue to test and initiate another connection, then it is possible that this would result in two conflicting connections between the same pair of subnets, and this cannot be allowed. Accordingly, a node must not initiate testing of a port if the port has already received an ATTACH_In_PROGRESS notification. Additionally, if a port receives any transaction (e.g. LOOP_TEST_PROBE, or LOOP_TEST_SYMBOL) with an ATTACH_In_PROGRESS on a port undergoing testing, then testing of that port will be abandoned (regardless of its current state).

The G bit ensures that consecutive TEST_VALUE numbers chosen by the Control Node are not the same. Some implementations are subjectively better at TEST VALUE number generation than others. For instance, a LFSR provides pseudo-random TEST_VALUE number generation and guarantees that consecutive values are different. A simple free running counter would not guarantee uniqueness between subsequent TEST_VALUE numbers. However, rather than have the Control Node continue to select TEST_VALUE numbers until they are different, the node may simply select a random new TEST_VALUE number and complement the G bit. Thus, relatively simple TEST_VALUE number generators can be used in conjunction with the G bit.

Unique consecutive LOOP_TEST_DATA values accelerate the testing process. The Control Node can detect a collision as soon as a received LOOP_TEST_SYMBOL matches the value in the HR because each LOOP_TEST_DATA value is different from the previous LOOP_TEST_DATA values. Thus the Control Node does not need to wait for the new test value to propagate through the network.

A node may have multiple ports in the UNTESTED state 504 of FIG. 5 simultaneously. Furthermore, ports may be placed in the UNTESTED 504 state by neighboring nodes which are performing loop tests.

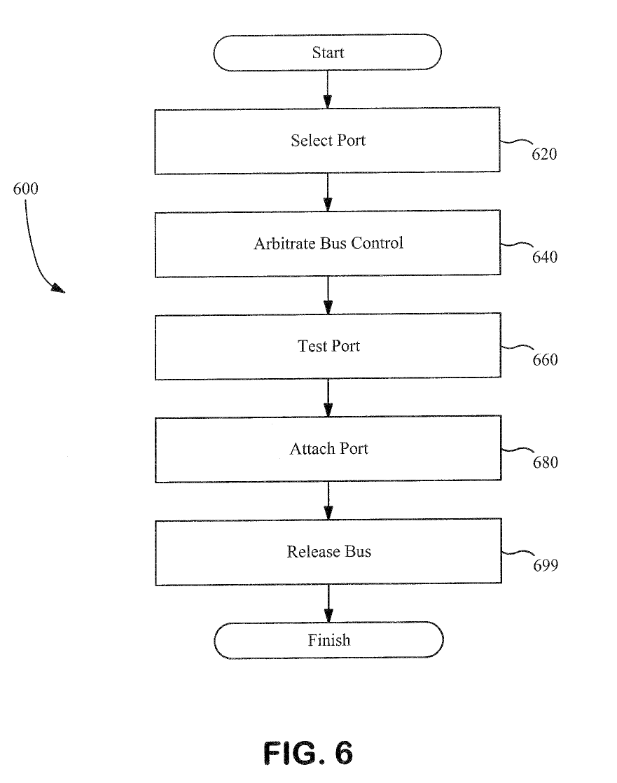

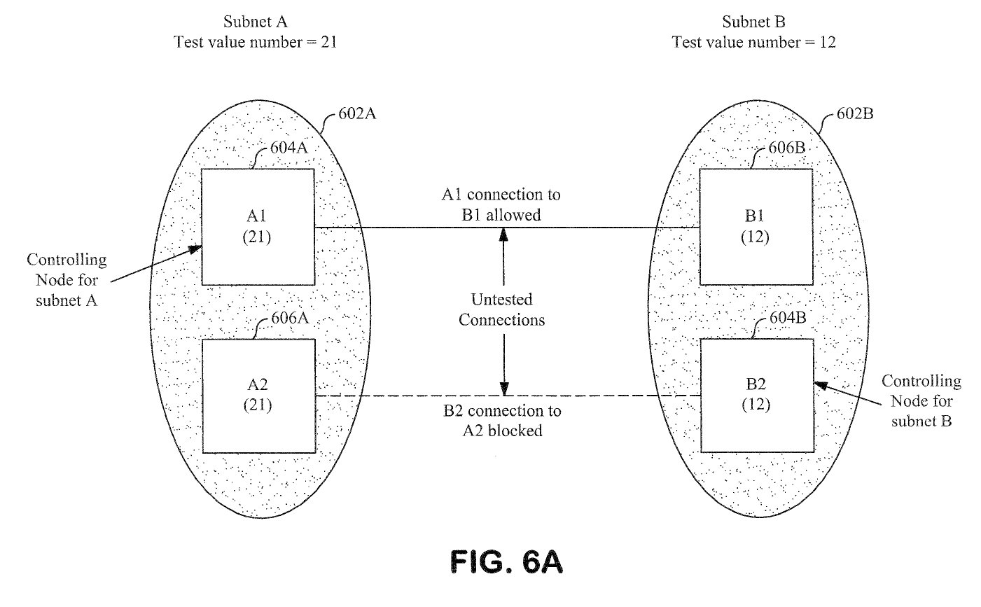

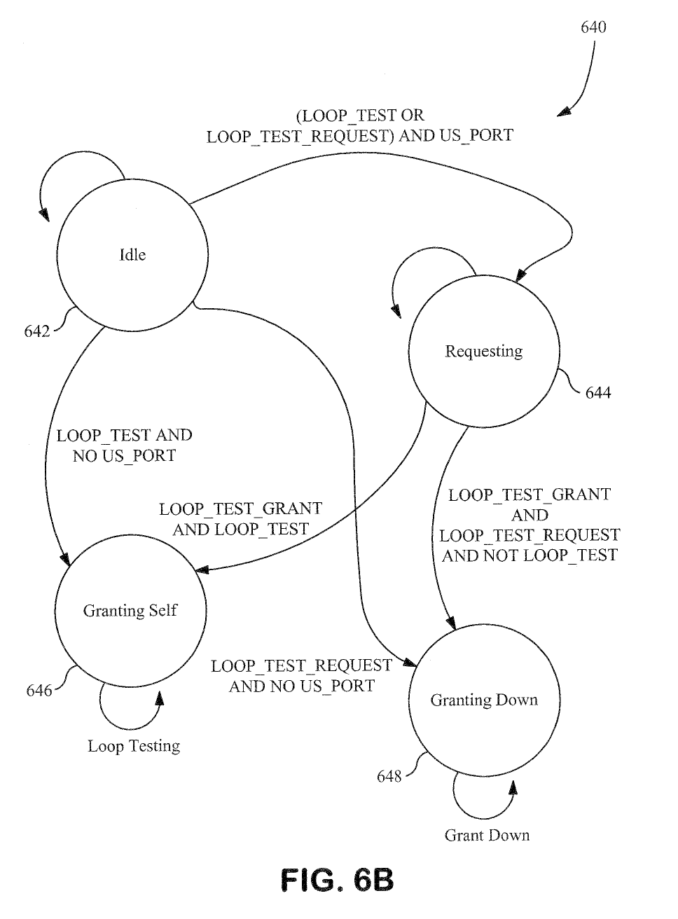

The logical flow diagram 600 of FIG. 6 herein illustrates one exemplary method for loop testing performed by a Control Node.

At step 620, the Control Node selects a port to be tested. When a node has one or more upstream ports in the UNTESTED 504 state, the selection of the current port to be tested (referred hereinafter as “test port”) may be implementation dependent. For example, the current test port may be selected based on a fixed succession, on a first-to-enter the UNTESTED 504 state basis, on the lowest numbered untested port, etc.

If a LOOP_TEST_SYMBOL has not been received on a port in the UNTESTED state, then that port will not be selected as the test port (at least until such symbol has been received). Conversely, if a LOOP_TEST_SYMBOL has been received, then the port may be set as the test port if the received LOOP_TEST_SYMBOL has a value that is less than the value in the HR.

In the instance that two previously unconnected networks are connected, only one of the two networks may test the network at a time. FIG. 6A illustrates two previously unconnected networks subnet A 602A and subnet B 602B each having a Control Node (604A, 604B), and other nodes (606A, 606B). In the scenario, the two networks are connected, nearly simultaneously. The networks arbitrate the dominant Control Node by comparing LOOP_TEST_DATA values.

The received LOOP_TEST_SYMBOL is in one variant compared to the stored

LOOP_TEST_DATA which is stored in the HR. The M bit of the received LOOP_TEST_SYMBOL is checked first. If the M bit is set to ATTACH_In_PROGRESS, then this port may not be selected as the test port. If the M bit indicates TEST mode, then the LOOP_TEST_SYMBOL is compared against the HR with the generation number being the most significant bit followed by the TEST_VALUE number.

If no untested port has received a LOOP_TEST_SYMBOL that is lower than the HR, then a port with an equal value may be selected. However, in this implementation, a port which receives a LOOP_TEST_SYMBOL that is greater than the HR should not be selected as a test port

The receipt of a new LOOP_TEST_PROBE may cause the node to choose a new test port. If the only port or ports in the UNTESTED state 504 on a given node are receiving an LOOP_TEST_SYMBOL that is greater than the HR, and the value of G in HR is zero (0), then the node: (i) arbitrates to be the Control Node, (ii) generates a new test value, (iii) flips the G bit to one (1), (iv) sends the new LOOP_TEST_PROBE on all active ports, (v) waits a TEST_INTERVAL, (vi) releases the network, and (vii) returns to comparing received LOOP_TEST_SYMBOL values with the HR as previously described.

Alternatively, if the only port or ports in the UNTESTED state 504 on a node are receiving a LOOP_TEST_SYMBOL that is greater than the HR, and the value of G in HR is one (1) (i.e. the value of G in the LOOP_TEST_SYMBOL is also one (1)), then the node sends a TEST_DOMINANCE_REQUEST on the port(s) currently in the UNTESTED state 504 to gain control over the network. This will cause the peer node(s) to select a new test value, and flip the G bit to zero (0). The node returns to comparing received LOOP_TEST_SYMBOL values with the HR.

Referring now back to FIG. 6A, the newly connected Controlling Node 604B of subnet B 602B compares the received LOOP_TEST_SYMBOL (i.e. 21) to the LOOP_TEST_DATA (i.e. 12) which is stored in its HR. The Controlling Node 604B establishes that it is subordinate to the Control Node 604A of subnet A 602A. Similarly, the other nodes of subnet A 606A disregard further requests from the Control Node 604B of subnet B 602B. The newly connected Controlling Node 604A of subnet A 602A compares the received LOOP_TEST_SYMBOL (i.e. 12) to the LOOP_TEST_DATA (i.e. 21) which is stored in its HR. The Controlling Node 604A establishes that it is dominant to the Control Node 604B of subnet B 602B. Controlling Node 604A transmits a TEST_DOMINANCE_REQUEST, and assumes control of the newly formed network.

Referring back to step 640 of FIG. 6, the node performs network arbitration and gains control of the net for loop testing purposes. Gaining control of the network (i.e. being designated the unique Control Node on the network) is necessary to avoid two nodes simultaneously performing loop testing. Each node with untested ports will arbitrate for network control according to the exemplary procedure described hereinafter.

Once a node is granted control, it proceeds to test the network connected downstream to the test port for one or more loops.

Once the Control Node is established, at step 660, the current Control Node performs a loop test, and initiates multiple sequential LOOP_TEST_PROBEs. For each subsequent LOOP_TEST_PROBE, the Control Node resets and restarts the test timer. The test starts when a LOOP_TEST_PROBE is sent on the active ports (i.e. upstream and downstream) and expires after the TEST_INTERVAL. Any other node that receives a LOOP_TEST_PROBE on an active port (a) updates the LOOP_TEST_SYMBOL set on all untested ports (if any) and (b) repeats the LOOP_TEST_PROBE on all other active ports (if any). The duration of TEST_INTERVAL should be chosen to allow the LOOP_TEST_PROBE to propagate to the furthest extremes of the network. During TEST_INTERVAL, the Control Node monitors the test port for the receipt of a LOOP_TEST_SYMBOL with matching LOOP_TEST_DATA (i.e., indicating a loop in the physical topology). During the test interval, the other nodes repeat the LOOP_TEST_PROBE (as per the aforementioned process). The Control Node compares the LOOP_TEST_DATA in the LOOP_TEST_SYMBOL received on the test port to the values in its HOLDING REGISTER. As long as the LOOP_TEST_DATA in the received LOOP_TEST_SYMBOL is not equal to the HR contents, and the mode of the received LOOP_TEST_SYMBOL is not ATTACH_In_PROGRESS, the test continues for the duration of the test interval.

If, however, at any time during the test interval the Control Node detects that the LOOP_TEST_DATA in the LOOP_TEST_SYMBOL is equal to the HR, then a collision condition exists. If a collision is detected, the Control Node will select a new random TEST_VALUE number, send a new LOOP_TEST_PROBE, and reset and restart the test interval timer. The Control Node will repeat this process up to a predetermined number of times (COLLISION_LIMIT) while in control of the network. If the Control Node detects COLLISION_LIMIT collisions in succession, then it will place the test port into QUARANTINED state 508, and either test the next successive port, or else release control of the network.

The COLLISION_LIMIT value is adapted to handle a situation where two selected TEST_VALUEs are the same. For example, if TEST_VALUE is a six (6) bit value, there is a slight ( 1/64) chance that two unrelated networks may choose the same TEST_VALUE. The aforementioned series of repeated loop tests are run to prevent false results. Also as described previously, some implementations are more sensitive to random chance than others (e.g. a LFSR may be preferred over a free running counter).

Furthermore, if the received LOOP_TEST_SYMBOL includes an ATTACH_In_PROGRESS, then the test of the port is abandoned, and the Control Node either tests the next successive port or releases control.

If no collision conditions exist, and the Control Node is dominant, then the Control Node will attach the port at step 680, before releasing the network at 699 for the next pending node.

Once a Control Node has established that the connection is valid, the Control Node finalizes the connection. The Control Node will transmit a LOOP_TEST_PROBE with an M bit set to ATTACH_In_PROGRESS. Although the test timer is no longer used, when the LOOP_TEST_PROBE is sent, the test timer may be reset and started. A LOOP_TEST_SYMBOL with the matching LOOP_TEST_DATA is sent on all untested ports except for the test port. On the test port, the Control Node transmits an ATTACH_REQUEST.

The ATTACH_REQUEST symbol indicates to the downstream node (which is connected to the test port, hereinafter the “attaching node”) that it is safe to transition the port to state ACTIVE 506. The Control Node waits to receive an ATTACH_COMPLETE from the attaching node.

When the Control Node receives the ATTACH_COMPLETE, it sets the M bit in the HR to TEST, and sends an LOOP_TEST_PROBE. It waits for a TEST_INTERVAL, and then releases control. The Control Node activates the port (i.e., responds to the link training request from the attach node).

### Downstream Facing Port Actions—

A downstream facing port responds to detecting HPD on a port by marking the port as UNTESTED 504, and sending an LOOP_TEST_SYMBOL on that port with the current value of the node's HR register. Whenever the HR register changes, the node sends the updated value on all UNTESTED 504 ports.

A node responds to receiving a TEST_DOMINANCE_REQUEST on a downstream facing port by arbitrating for control. Then, when it gains control, it: (i) selects a new test value, (ii) flips the G bit, (iii) sends the LOOP_TEST_PROBE on all active ports, (iv) sends the new LOOP_TEST_SYMBOL on all untested ports, (v) waits for TEST_INTERVAL, and then finally (vi) releases control.

A node responds to receiving an ATTACH_REQUEST on a downstream facing port by arbitrating for control of its network. When it wins arbitration, it then: (i) sends an ATTACH_COMPLETE, (ii) releases control of the net, and (iii) activates the port (which will result in a link training request being sent to the Control Node). The link training request is the first step in activating a port for data transfer. Once link training has assessed the link capacity, unidirectional high speed links of data (e.g. audio, video, etc.) can be sent over the connection.

The attach node continues to send LOOP_TEST_SYMBOL updates to the control node up to the time it sends ATTACH_COMPLETE. If, at any time before it has been granted control, it sends a mode bit (M) with ATTACH_In_PROGRESS, then it withdraws its arbitration requests and releases control if it has gained control and does not send an ATTACH_COMPLETE.

### Actions on Disconnect Detection—

When a node detects a disconnect on any active port, then it updates all quarantined ports to the UNTESTED state 504, and sends a LOOP_RETEST message on all active ports. When a node receives a LOOP_RETEST message on a port, it updates all quarantined ports to the UNTESTED state 504, and sends a LOOP_RETEST message on all remaining active ports.

It is noted that in the described embodiments, the Control Node is not allowed to hold its net for an arbitrary amount of time. An overall duration of TEST_INTERVAL is defined. If this expires at any point in the process, then the Control Node clears

ATTACH_In_PROGRESS, sends out an updated LOOP_TEST_PROBE, waits TEST_INTERVAL, releases control, and de-asserts HPD on the Test port for a minimum of 2 ms (forcing an apparent disconnection), marking the port as not connected.

The Control Node may detect a disconnection on a test port. In this case, it abandons testing following the above procedure.

A disconnection may be detected on a downstream-facing UNTESTED 504 port. If the node has control of the net because it has received an ATTACH_In_PROGRESS on this port, then it clears ATTACH_In_PROGRESS, sends out an updated LOOP_TEST_PROBE, waits TEST_INTERVAL, and then releases control, marking the port as not connected.

### Exemplary Network Arbitration—

One exemplary scheme for network arbitration is illustrated in FIG. 6B. As stated in the description of exemplary process 600 of FIG. 6, it is necessary to ensure that only one node on the net conducts loop test operations (i.e., is designated and acts as the Control Node) at any given time. Multiple nodes may contend for performing loop test operations; however, only one of the contending nodes may be granted control at a time. When the first Control Node releases its control over the net, one of the other still-contending nodes is successively granted control.

Each node requiring or requesting control sends one or more requests on its upstream ports. These requests eventually arrive at all of the connected sources which can source AV data to this node. Each source receiving the requests sends out a grant to only one requesting downstream node. Intermediate nodes between the requesting nodes and the source nodes pass down the received grant to only one requesting downstream port until a grant arrives at a requesting node.

Every node can be in one of four arbitration states: (i) IDLE 642, (ii) REQUESTING 644, (iii) GRANTING SELF 646, or (iv) GRANTING DOWN 648.

A node in the IDLE state 642 wishing to perform loop testing and having one or more active upstream ports moves into the REQUESTING state 644. If it has no active upstream ports, the node moves immediately into the GRANTING SELF state 646.

A node in the IDLE state 642 receiving a LOOP_TEST_REQUEST from a downstream port and having one or more active upstream ports moves into the REQUESTING state 644. If the node has no active upstream ports (for example because it is a DisplayPort Source), it moves immediately into the GRANTING DOWN state 648.

A node entering the REQUESTING state 644 issues a LOOP_TEST_REQUEST on all active upstream facing ports, and waits for a LOOP_TEST_GRANT to be received on all such ports. On receipt of the LOOP_TEST_GRANT, the node moves into the GRANTING SELF state 646. Alternatively, if the node does not wish to perform loop testing but has downstream ports from which a LOOP_TEST_REQUEST has been received, it enters the GRANTING DOWN state 648.

A node entering the GRANTING SELF state 646, and which has one or more upstream ports in the untested state, becomes the Control Node and performs loop testing on one of those ports.

A node entering the GRANTING DOWN state 648 with no upstream ports in the untested state (but with one or more downstream ports from which it has received a LOOP_TEST_REQUEST) selects one of the downstream facing ports from which it has received a LOOP_TEST_REQUEST, and sends a LOOP_TEST_GRANT on that port. Selection under this option may be performed in any implementation-dependent manner, or according to a generic selection algorithm as desired.

A node in the REQUESTING state that receives a LOOP_TEST_GRANT from all of its active upstream ports, but has no upstream ports in the UNTESTED state, and no downstream ports from which it has received a LOOP_TEST_REQUEST, in one embodiment sends a LOOP_TEST_RELEASE on all active upstream ports (if any), and enters the IDLE state 642. This is not shown within the state machine of FIG. 6B. For example, if a port is disconnected, or if between making the request and receiving the grant some other node becomes the Control Node first, then the request will be withdrawn (i.e., due to a LOOP_TEST_RELEASE).

A node in the GRANTING DOWN state 648 may receive a LOOP_TEST_RELEASE from a downstream-facing port, or may detect a disconnection on a downstream facing port from which it last received a LOOP_TEST_REQUEST. In either case, if it has one or more other downstream ports from which it has received a LOOP_TEST_REQUEST, it selects (e.g., in an implementation-dependent or generic manner as previously described) one of the downstream facing ports from which it has received a LOOP_TEST_REQUEST, and sends a LOOP_TEST_GRANT on that port. If it has no other downstream ports from which it has received a LOOP_TEST_REQUEST, the node sends a LOOP_TEST_RELEASE on all active upstream ports (if any), and enters the IDLE state 642.

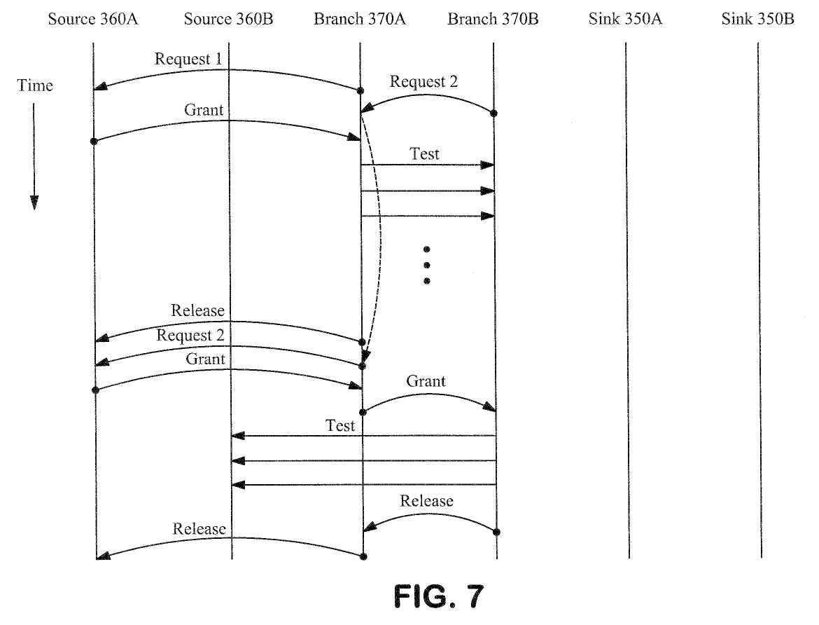

FIG. 7 is a ladder diagram illustrating one exemplary signal exchange according to the logic of the state machine 640 of FIG. 6B. The signaling exchange of FIG. 6B is shown with respect to the simple system 400 of FIG. 4. Two new connections are made: i) the first branch node 370A has an upstream connection to the second branch node 370B (i.e., forming a loop), and ii) the second branch node has a connection to a second source node 360B. Responsive to the new connections, the first and second branch nodes (370A, 370B) both request Control Node capability from the extant master source node 360A.

Initially, both the first branch node 370A and second branch node 370B request Control Node capability from the extant master source node 360A. The master source node grants Control Node capabilities to the first branch node. The first branch node proceeds to test its upstream ports, and quarantines the detected loop. Once the first branch node has concluded its testing, it relinquishes control back to the master source node.

The master source node then grants Control Node capabilities to the second branch node. The second branch node tests its upstream ports, and activates the newly discovered source node 360B. At the conclusion of testing control is passed back to the master source node 360A, and operation proceeds normally.

Degenerate Cases—

As previously noted, one or more degenerate cases may exist within a given A/V network under certain conditions. These are now described in greater detail.

In a first instance, two downstream facing ports are connected. In this instance, neither port will generate an HPD signal (since an upstream or “receiver” port is required in order to receive a signal present on the cable), and both ports will await an HPD signal. Consequently the presence of a connection will never be detected, and there is no need for any explicit loop testing. In one variant, HPD is a unidirectional signal—implemented as a separate conductor—sent by the upstream facing port and received by the downstream facing port.

In a second instance, two upstream facing ports are connected. In this instance, both nodes will pull AUX-low, so neither node will detect a peer powered source, and both will not assert HPD.

It is noted that a concern in some operational scenarios relates to disruption of an extant network; i.e., the currently running network should not be disrupted by any new connection that is formed. But in degenerate cases such as those provided above, the AUX channel communication is not functional either (regardless of the loop healing methods described herein). Accordingly, under this scenario, there is no way for the source (typically a computer) to be able to communicate to devices that are on the far side of a “degenerate” connection.

Hence, in another embodiment of the invention, a mechanism for communication across such “degenerate” connections (e.g., having the aforementioned AUX signal function around or through the degenerate connection) is required in order to provide signaling indicating the existence of the degenerate connection. Other mechanisms or techniques may be used as well, consistent with the present invention.

### Application Software—

In another embodiment of the invention, application software is used in conjunction with the detection and “healing” algorithms previously described to solicit user participation in the connection/breaking/reconfiguration process; i.e., in those cases where the healing algorithms cannot rectify the problem. For instance, in the case where a quarantined port case is created, the software application running on the host device (e.g., the user's “source” PC) would generate a GUI display or other output to alert the user as to the quarantined port requiring their attention (i.e., removing one end of the cable from one of the upstream/downstream ports, and reconnecting it to another location such as a downstream/upstream port (respectively) on another device.

### Business Methods—

In another aspect of the invention, exemplary methods of doing business relating to the foregoing unidirectional network management capabilities are disclosed.

In one embodiment, the unidirectional network management capabilities enabled by the invention can be marketed and leveraged. For example, a device manufacturer or service provider can differentiate their product or service over others based on the ease of use, flexibility of connectivity, and general robustness. In certain applications, (such as audio visual devices) the flexibility of the system to dynamically add and subtract components of varying qualities and characteristics can also be used as a basis of differentiation or to support a higher price. By giving consumers the ability to control their component network without having to necessarily understand the signal or topological implications of each connection they make, the customer will ostensibly be willing to pay more either in terms of initial price or ongoing subscription fees. Such “idiot proof” devices are truly freeing from a consumer or end-user's perspective, since they merely need connect the wiring until the network functions as they desire. In other words, the system has enough innate intelligence as described herein to resolve any redundancies or misconfiguration in wiring by itself.

In one example, a home theater aficionado may be comforted by the fact that they may incrementally improve their initial capital outlay (e.g., projector/video display, and theater sound system), simply by adding more components as he or she sees fit. Furthermore, in some cases, the overall user experience is qualitatively better, as the new technology transparently “works” out of the box, as opposed to requiring extensive and potentially difficult reconfiguration, and/or consultation with online or service call experts. Many people are inhibited from buying and installing more complex AN systems themselves because they perceive the wiring and connection to be difficult or insurmountable.

In another aspect of the invention, a business model revolving around yet further innate “intelligence” is presented. Specifically, a user can access a database or other knowledge repository via an algorithm (e.g., computer application) which permits the user to enter information about their proposed network configuration and equipment, in order to obtain more explicit instructions on how to connect the devices. For instance, a user may provide information indicating that they currently possess an Model 123 computer manufactured by Manufacturer A, and a first monitor (model 456) manufactured by Manufacturer B, and want to add a second monitor with webcam and microphone (model 789) manufactured by Manufacturer C, so as to permit simultaneous viewing and Internet interaction via the second monitor. This information may be input via a GUI or other user interface to the application. The application then accesses information regarding these models of the device (e.g., from pre-stored data, via the Internet, etc.) and determine their input/output ports and interfaces. The application then graphically shows the user (such as via the extant display device) how to connect the devices properly for a specific requested functionality, or alternatively could show the user all of the possible locations where the new device may be connected and still maintain functionality (i.e., so as to avoid any non-detectable degenerate cases).

The foregoing approach improves upon prior art “card instructions” (e.g., simplified and highly graphical cards typically included with PCs and other consumer devices which show a user how to connect various devices together at setup), in that particular devices (e.g., Model 123, Model 456, etc.) and proposed combinations of devices, can be addressed holistically and in a systemic fashion, versus just the options presented on a card. When coupled with the “self healing” and robustness aspects of the present invention (previously described), the user is given the best of both worlds; i.e., a substantially “idiot proof” solution which, even if the user finds some way to confound, can ultimately be corrected via a simple and easy-to-use user interface and associated application software to instruct them (e.g., step by step) on how to rectify their problem and/or set up the desired configuration in the first place.

The foregoing functionality may be implemented directly on one of the user's devices (e.g., such as via an installed application, or one carried on a CD ROM or other media, or downloaded from the Internet), or alternatively via a manufacturer's or service provider's website on the Internet (e.g., in cases where the equipment is being set up for the first time, and is not yet functional).

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for topological resolution within a physical network, wherein the physical network comprises a plurality of devices, the method comprising:
monitoring the physical network for a trigger event, the trigger event indicating a change to the physical network;
identifying one or more confounding structures;
determining a logical network topology, wherein the logical network topology quarantines the confounding structures of the physical network; and
activating the logical network to provide a unidirectional and unconfounded network of the devices.

2. The method of claim 1, wherein the network comprises at least one DisplayPort-compliant device.

3. The method of claim 2, wherein the one or more confounding structures comprises a loop.

4. The method of claim 2, wherein the one or more confounding structures comprises a non-unique signal path.

5. The method of claim 1, wherein the trigger event comprises connection of a display device to the network.

6. The method of claim 1, wherein the method is performed substantially automatically and without user intervention.

7. The method of claim 1, wherein the plurality of devices comprise a sink device and a source device, and the unidirectional and unconfounded network of the devices further comprises a channel capable of providing at least one of capability and/or status information to be transferred from the sink device to the source device.

8. The method of claim 7, wherein the source device comprises a master device, and the sink device comprises a slave device under control of the source.

9. The method of claim 8, wherein the method further comprises using the source device to controls both: (i) the transmission of the at least one capability and/or status information between the source device and the sink device, and (ii) the higher level management of the display and network.

10. A robust apparatus configured to resolve user-instigated malconfigurations, the apparatus comprising:
first logic to identify one or more confounding structures;
second logic to determine a logical network topology, the logical network topology being effective to quarantine the confounding structures; and
third logic to configure the logical network to provide a unidirectional and unconfounded network of devices.

11. The apparatus of claim 10, wherein the first logic is configured to detect the one or more confounding structures upon connection or removal of one of the devices to the network, the detection being accomplished at least in part using one or more signals carried over one or more pins of a connector by which the one device is connected.

12. The apparatus of claim 11, wherein the one or more signals comprise a Hot-Plug Detect (HPD) interrupt signal.

13. The apparatus of claim 11, wherein the one device comprises a DisplayPort 1.2-compliant device.

14. The apparatus of claim 10, wherein the one or more confounding structures comprise a loop or a non-unique signal path.

15. The apparatus of claim 10, wherein the apparatus comprise a laptop, desktop, or handheld computer, and the identification, determination and configuration are performed substantially automatically and without user intervention.

16. A method of enabling the functioning of a network of devices connected in an otherwise at least partly inoperative configuration, the at least partly inoperative configuration having a plurality of possible logical mappings of physical topology, the method comprising:
arbitrating the plurality of possible logical mappings, the arbitrating comprising at least one of (i) bus arbitration and/or (ii) messaging for topology resolution; and
selecting a single one of the possible mappings;
wherein the arbitrating and selecting precludes the network from failing in the at least partly inoperative configuration.

17. Computerized apparatus for use in a substantially unidirectional audio-visual device network, comprising:
a processor;
a storage device in data communication with the processor;
at least one auxiliary communication channel capability useful for management and data control; and
at least one computer program resident on the storage device configured to, when executed on the processor:
detect at least one malconfiguration within the audio-visual device network to which the device is connected;
use the at least one auxiliary channel capability to perform at least one of bus arbitration and messaging for topology resolution; and
based at least in part on the at least one of bus arbitration and messaging, generate a logical topology having unique and finite path properties.

18. The apparatus of claim 17, wherein the apparatus comprises a desktop or mobile computer device, and the auxiliary channel capability comprises a bi-directional channel capability.

19. The apparatus of claim 18, wherein the network comprises at least one master node and at least one slave node, and the at least one computer program is further configured to perform an arbitration process that delegates control responsibility from a master node to a slave node.

20. The apparatus of claim 19, wherein the apparatus comprises the master node.

21. The apparatus of claim 19, wherein the delegation comprises:
delegation of the control to a maximum of one slave node at any one time; and
reacquisition of the control at the master node when the slave node relinquishes the control.
